(19) United States
(12) Patent Application Publication
(10) Pub. No.: US 2005/0243066 A1
(43) Pub. Date: Nov. 3, 2005

(54) Command line interface in a communication system

(75) Inventors: Huimin Li, Shrewsburg, MA (US); Wei Mao, Worcester, MA (US); Eric Gieseke, Lincoln, MA (US)

Correspondence Address: Fogg and Associates, LLC, P.O Box 581339, Minneapolis, MN, 55458-1339, US

(73) Assignee: ADC Broadband Access Systems, Inc.

(21) Appl. No.: 10/833,625

(22) Filed: Apr. 28, 2004

(51) Int. Cl. G09G 5/00

(52) U.S. Cl. 345/168; 345/172

(57) ABSTRACT

A help mechanism with regard to commands for a command line interface in a communication system. In embodiment a method of operating a command line interface (CLI) in a communication system is disclosed. The method comprises displaying tokens and associated context specific descriptions for CLI commands in response to a first command key.

### TECHNICAL FIELD OF THE INVENTION

The present invention relates generally to communication systems and in particular a help mechanism relating to commands available for a command line interface in a communication system.

### BACKGROUND OF THE INVENTION

Controlling a cable modem communication system is typically done with commands from a command line interface (CLI). The commands generally provide a lot of options and tend to be complicated. A CLI may provide general help information designed to aid the operator in selecting desired commands. Such help mechanisms typically provide a brief description of commands and each commands possible arguments. However, the general help information and implementation of the help information is typically only helpful to operators who have a significant amount of experience in providing commands. What is needed in the art is a user friendly system that operators with minimal experience can operate effectively.

For the reasons stated above, and for other reasons stated below that will become apparent to those skilled in the art upon reading and understanding the present specification, there is a need in the art for user friendly method of providing help information to an operator regarding command instructions in a cable modem communication system.

### SUMMARY

The above-mentioned problems and other problems are resolved by the present invention and will be understood by reading and studying the following specification.

In one embodiment, a method of operating a command line interface (CLI) in a communication system is disclosed. The method comprises displaying tokens and associated context specific descriptions for CLI commands in response to a first command key.

In another embodiment, a method of providing help in controlling a communication system is disclosed. The method comprises entering a first command key and displaying tokens and associated context specific descriptions relating to a command line interface (CLI) command in response to the first command key.

In further another embodiment, a computer-usable medium having computer-readable instructions stored thereon for execution by a processor to perform a method is disclosed. The method comprises processing a help request from a command line interface (CLI). Providing a list of context sensitive tokens in response to the help request. Linking associated definitions and applicable parameters for a particular command to each token and displaying the associated description and applicable parameters.

In yet further another embodiment, a management module in a communication system is disclosed. The management module comprises a completer and parser. The completer is adapted to pass a list of tokens to a display of a command line interface (CLI) in response to a first key command key received from the CLI and to pass the list of tokens to a parser in response to a second key command from the CLI.

In still yet another embodiment, a cable modem communication system is disclosed. The communication system comprises a command line interface (CLI) and management module. The CLI is adapted to provide commands to the cable modem communication system. The CLI has an operator interface and a display. The management module is in communication with the CLI. The management module includes a completer and a parser. The completer is adapted to provide a list of tokens to the parser and the parser is adapted to pass on to the CLI only tokens related to a specific mode of operation.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram of a portion of a cable modem communication system of the prior art.

FIG. 2 is a diagram of a CLI help hierarchy of one embodiment of the present invention;

FIG. 3, is a block diagram of a communication system of one embodiment of the present invention; and

FIG. 4 is a flow chart illustrating a helping information sequence in one embodiment of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, electrical or mechanical changes may be made without departing from the scope of the present invention. The following detailed description is, therefore, not to be taken in a limiting sense, and the scope of the present invention is defined only by the appended claims and equivalents thereof.

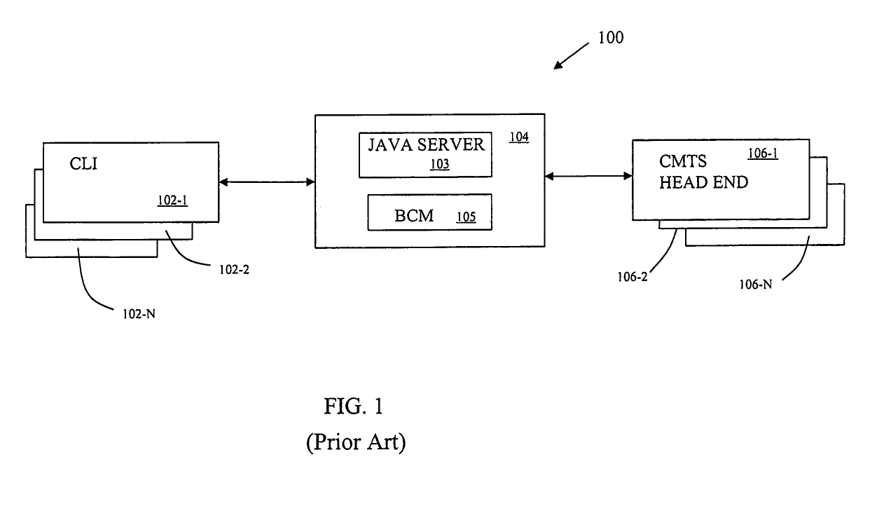

Embodiments of the present invention provide a new command line interface (CLI) mechanism. The CLI mechanism of one embodiment of the present invention invokes a text based hyper text markup language (HTML) file browser (such as Lynx) and allows the operator to browse an online electronic version of a CLI command reference. These embodiments provide detailed help information that includes command explanation, command examples and links to all related commands. Referring to FIG. 1, a partial cable modem communication system 100 is illustrated to provide further background of the present invention. As illustrated in FIG. 1, the cable modem communication system comprises a plurality of CLIs (1-N), a management module 104 and a plurality of cable modem termination system (CMTS) headends 106 (I-N). Each CLI can also be referred to a user interface. Each CLI 106 provides an interface to the cable modem system so an operator can provide commands to the cable modem system. The management module in this embodiment includes a JAVA server 103 with a bas cluster manager (BCM) 105. Each CMTS headend 106 provides an interface between associated cable modems (not shown) and the cable modem communication system 100. Further description of communication systems are illustrated and described in the commonly assigned U.S. patent application Ser. No. 10/696,233 which is herein incorporated by reference.

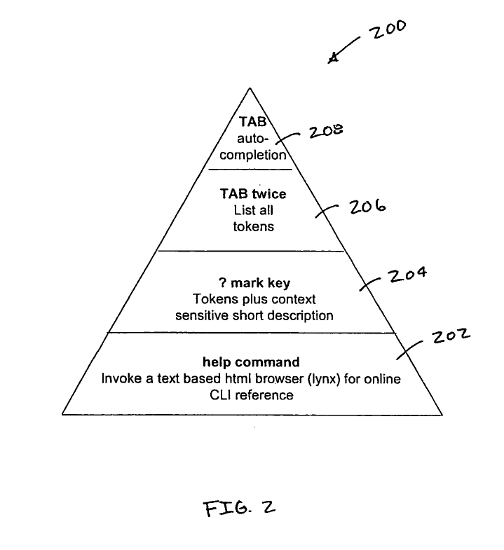

As stated above, the present invention provides user friendly help options to an associated CLI to assist in providing commands to a communication system. Embodiments of the present invention provide a mechanism to support context sensitive short description for CLI commands. Further in one embodiment, the context sensitive short descriptions are invoked by pressing (activating) a “?” command key on an associated keyboard. Depending on the particular mode, available command tokens with short descriptions associated with the mode are displayed. Moreover, in one embodiment, if a user had already entered a partial command, all applicable parameter, parameter's description and possible range of the parameter are displayed. FIG. 2 illustrates a hieratical helping scheme of one embodiment of the present invention. It provides comprehensive line help. As illustrated, the hieratical helping schemes has four different levels. The first level is the help command level 202. This help invokes a text based HTML browser (such a lynx) for online CLI reference in one embodiment of the present invention. At the next level is the “?” mark key level 204. This help level provides tokens plus a context short description. A token represents a defined and distinct command. At the “?” level 204, only tokens that are available to the operator are displayed. The next level is the Tab twice level 206. This level lists all tokens. At the top level is the Tab level 208. This level is an auto-completion level that saves the user from further typing when a partial token for a command or option of a command has already been entered. In one embodiment of the present invention, this auto completion level is evoked by entering the “tab” command key once.

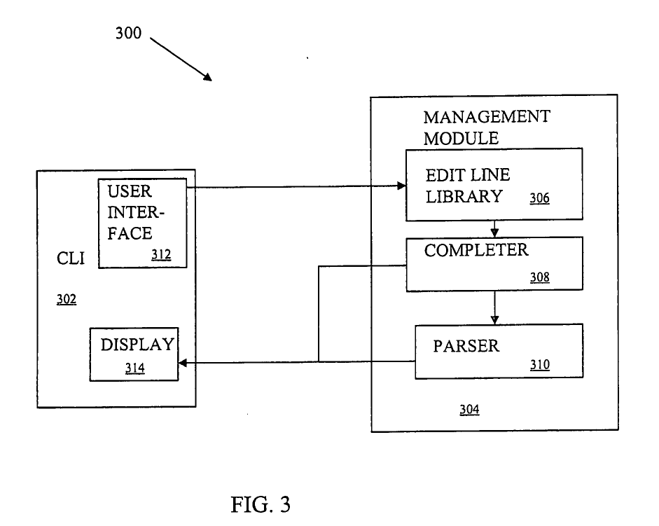

Referring to FIG. 3, a block diagram of a partial communication system 300 of the present invention is illustrated. The partial communication system 300 illustrates the interaction between a CLI 302 and a management module 304 of one embodiment of the present invention. As illustrated, the CLI 302 includes a user interface 312 and a display 314. The Management module 304 includes an edit line library 306, a completer 308 and a parser 310. When an operator enters a “?” key or the TAB key twice on the user interface 312 of the CLI 302, the edit line library 306 invokes the completer 308. The edit line library 306 provides a list of context sensitive tokens which represent either available commands or applicable parameters for a particular command. If the completer 308 is invoked by a tab key the token list will be displayed on the CLI's display 314. However, if the completer 308 is invoked by a “?” key the token list is directed to the parser 310. The parser 310 passes only tokens on to the CLI's display 314 that are related to the mode of the mechanism. In addition, if a command line already has a partial entry, tokens will be appended this partial entry and feed into the input stream before invoking the parser. For example, if the command line contains the partial entry “upstream 1,” a token will be appended to this partial entry so it becomes “upstream 1 frequency.” Once invoked, the parser examines the input stream and passes only tokens goes through all possible nodes contained in the input stream. A node holds a short description that is associated with a specific token.

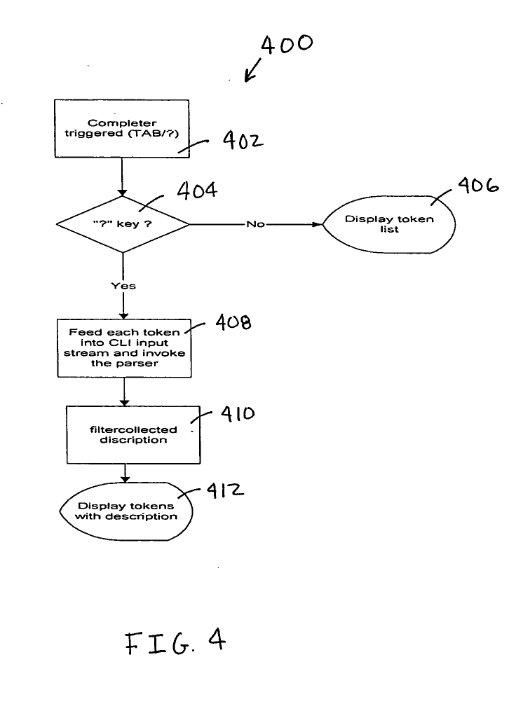

Referring to FIG. 4, a flow chart 400 illustrating the process of one embodiment of the present invention is illustrated. As illustrated, this process starts when the completer is triggered by activating either a TAB or “?” command key (402). It will be understood in the art that any command key could be used and the present invention is not limited to just the TAB and “?” keys. It is then determined if the it was the “?” key (404). If it was not the “?” key (404), the whole token list is displayed. If it was the “?” key (404), each token is feed into the CLI input stream and the parser is invoked (408). The tokens are then filtered by the parser since we are only interested in a subset of tokens and their associated descriptions (410). The filtered tokens and descriptions are then displayed to the operator (or user).

As discussed above, some embodiments of the present invention use a JAVA completer. The following involves a detailed description of an embodiment of the present invention using a JAVA completer. In particular, the invocation of context sensitive short descriptions using a JAVA Completer is further described. Handling of the tab key and the “?” command key is implemented in Readline.C in this embodiment. The handling function in turn invokes the java completer function via editline JN1 library. In this embodiment, we notify the java completer that we are handling a “?” inquiry. Examples of modifications to modules of one embodiment of the present invention are as follows:

a. readline.h

| | |
|---|---|
| i. | //change the callback function signature to include a flag for |
| | question |
| ii. | //mark key |
| iii. | typedef char *CPFunction(const char *, int, int); |

b. readline.c

| | |
|---|---|
| i. | //set the question mark flag and pass the flag to JNI function |
| ii. | (*genfunc)(text, matches, question_markpressed)) |

c. org_gnu_editline_Readline.c

| | |
|---|---|
| i. | //this module implements the JNI function to interact with java |
| | code, |
| ii. | //modify the function signature to pass the “?” key status |
| iii. | const char *java_completer(char *text, int state, |
| | intquestion_mark-key) |

d. ReadlineCompleter.java

| | |
|---|---|
| i. | //This module defines the completer interface and modifies |
| | it to take the |
| ii. | //question mark key status |
| iii. | public string completer(String text, int state, int questionMark); |

e. BasCliBase.java

| | |
|---|---|
| i. | //this class contains an inner RLcompleter class which |
| | implement the |
| ii. | //completer interface as defined in Readlineompleter interface. |
| | Modify the |
| iii. | //implementation to handle the question mark flag. |
| iv. | Class RLcompeter implements ReadlineCompleter |
| v. | { |

| | |
|---|---|
| 1. | public String completer (String partial Word, ints, int |
| | quesitonMark) |

| | |
|---|---|
| vi. | } |

The request is then formulated. When the completer is called in this embodiment, it invokes the parser, which gives a parser exception since the parser's input stream is either empty or contains an incomplete command. The exception contains a list of available tokens in a current command-line context. If the completer is invoked by the TAB key, the token list will be displayed. In the case of the “?” key command, the token list is looped through and individual tokens are fed into the parser's input stream and the parser is invoked. This forces the parser to examine corresponding nodes for the tokens. The nodes hold the short descriptions which are collected when examined.

In one embodiment, tokens for such things as MAC addresses and IP addresses are represented as strings such as <mac address> and <ip address>. These strings of syntax are converted in this embodiment to values the parser understands before they are passed into the parser's input stream. For example, “<ip-address>” is converted to “1.1.1.1.” A pseudo code of one embodiment to formulate the input stream is as follows:

| | |
|---|---|
| a. | //completionVector holds all applicable tokens |
| b. | //partialLine holds partial command |
| c. | replaceValueTokens(completionVector); |
| d. | for(int i=0; I,completionVectro.size( ); i++) |
| e. | { |
| f. | String token + (String)completionVector.elementAt(i); |
| g. | insertToInputStream(partialLine, token); |
| h. | mCliParser.ReInit(newStream); |
| i. | mCliParser.ToplevelExpression( ): |
| j. | } |

Moreover, there is another complication when dealing with value tokens. For many value tokens multiple syntax are allowed. For example, when setting upstream channel frequency, the value of the frequency can either be an integer or a float. To deal with this, one embodiment of the present invention combines the tokens into a single string representation. For example, instead of two separate tokens of <integer> and <float>, a single representation of <integer, float> is used. In a further embodiment, this conversion is done in the function of “replaceValueTokens.” Moreover, in the CLI parser's code (BasCli.jjt), we need to modify these composite tokens by invoking a “setTypoInfo” function to match the combined tokens names. This requires going through all composite value tokens in the parser file.

When the parser is invoked it goes through each node. This invokes a setHelpInfo and setBasType functions as defined in module SimpleNodejava. The setHelpINfo creates the short description and setBasType obtains range information for the parameters. If the token name in the node matches the token name expected, both the token name and its description will be stored into a vector for displaying. For example, if the “?” key is pressed when the command line contains a partial command such as “upstream 1,” the parser will produce a token list related to “Upstream 1” such as:
a. channel-width data-backoff frequency map
b. Minslot-size modulation-profile no power-level
c. Range-backoff ranging shutdown voice-bw-reserve

In one embodiment the token list is displayed in a table format. Moreover, in one embodiment this is done by following existing functions in BASCliFormatter. This will automatically take care of issues of paging, wrapping the column and etc. An example is as follows:

```
a. buildCoulmnRows (columnVector,
      1. columnWidth,
      2. BasCliFormatElement.Ailignment.USE_DEFAULT,
      3. lable);
      4. outputRows (String row);
```

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although specific embodiments been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

1. A method of operating a command line interface (CLI) in a communication system, the method comprising:
displaying tokens and associated context specific descriptions for CLI commands in response to a first command key.

2. The method of claim 1, further comprising:
filtering tokens based on a partial command entry, wherein only tokens and their associated descriptions relating to a partial CLI command are displayed.

3. The method of claim 1, wherein the first command key is the “?” key.

4. The method of claim 1, further comprising
displaying a list of tokens in response to a second command key.

5. The method of claim 4, wherein the second command key is the “TAB” key.

6. The method of claim 46 wherein the second command key has to be activated twice.

7. The method of claim 1, wherein the tokens are available commands and applicable parameters for particular commands.

8. A method of providing help in controlling a communication system, the method comprising:
entering a first command key; and
displaying tokens and associated context specific descriptions relating to a command line interface (CLI) command in response to the first command key.

9. The method of claim 8, further comprising:
displaying parameter information associated with select tokens.

10. The method of claim 8, further comprising:
entering a second command key;
displaying a list of all possible tokens.

11. The method of claim 8, further comprising:
entering a third command key when a partial token has been enter to automatically complete the token request.

12. The method of claim 8, further comprising:
parsing the tokens to display only tokens related to the specific CLI command.

13. The method of claim 12, further comprising:
reviewing all nodes in an input stream.

14. A computer-usable medium having computer-readable instructions stored thereon for execution by a processor to perform a method comprising:
processing a help request from a command line interface (CLI);
providing a list of context sensitive tokens in response to the help request;
linking associated definitions and applicable parameters for a particular command to each token; and
displaying the associated description and applicable parameters.

15. The computer-usable medium of claim 14, further comprising;
storing tokens and their associated descriptions in a vector for displaying.

16. The computer-user medium of claim 14, further comprising:
filtering out duplicate tokens.

17. The computer-user medium of claim 14, further comprising:
displaying the token and description and applicable parameters in a table.

18. The computer-usable medium of claim 17, further comprising:
combining tokens with multiple syntax into a single representation.

19. The computer-useable medium of claim 14, further comprising:
parsing the list of tokens so that only available tokens in an operation mode are displayed.

20. The computer-usable medium of claim 19, wherein the operation mode is determined by a partial command entry in the CLI.

21. The computer-usable medium of claim 19, further comprising:
associating nodes that hold the definitions and applicable parameters to the available tokens.

22. The computer-usable medium of claim 21, further comprising:
converting an unrecognizable syntax of a string of values to a recognizable syntax so correct nodes are associated with the correct tokens.

23. A management module in a communication system, the management module comprising:
a completer adapted to pass a list of tokens to a display of a command line interface (CLI) in response to a first key command key received from the CLI and to pass the list of tokens to a parser in response to a second key command from the CLI.

24. The management module of claim 23, further comprising:
an editline library containing the list of tokens in communication with the completer.

25. The management module of claim 23, wherein the parser is further adapted to pass on select tokens and associated descriptions of said token to the display of the CLI.

26. The management module of claim 25, further wherein the select tokens are tokens available as determined by a partial command received from the CLI.

27. The management module of claim 25, further wherein the select tokens also include relevant parameters available.

28. A cable modem communication system; the communication system comprising:
a command line interface (CLI) adapted to provide commands to the cable modem communication system, the CLI having an operator interface and a display; and
management module in communication with the CLI, the management module having a completer and a parser, the completer is adapted to provide a list of tokens to the parser and the parser is adapted to pass on to the CLI only tokens related to a specific mode of operation.

29. The communication system of claim 28, wherein the specific mode of operation is determined by a partial command entry in the CLI.
